(19) United States
(12) Patent Application Publication
(10) Pub. No.: US 2025/0352909 A1
(43) Pub. Date: Nov. 20, 2025

(54) Artificial Intelligence Model Training Method and Apparatus, Device, Medium, and Program Product

(71) Applicant: Tencent Technology (Shenzhen) Company Limited, Shenzhen (CN)

(72) Inventors: Jingwen Yang, Shenzhen (CN); Yichi Xiao, Shenzhen (CN); Nan Hu, Shenzhen (CN); Hao Zhou, Shenzhen (CN)

(21) Appl. No.: 19/288,039

(22) Filed: Aug. 1, 2025

Related U.S. Application Data
(63) Continuation of application No. PCT/CN2024/098019, filed on Jun. 7, 2024.

(30) Foreign Application Priority Data
Jul. 25, 2023 (CN) 2023109238917

(51) Int. Cl. A63F 13/67; A63F 13/56; G06N 20/00

(52) U.S. Cl. CPC A63F 13/67; A63F 13/56; G06N 20/00

(57) ABSTRACT

Provided are an artificial intelligence model training method and apparatus, a device, and a storage medium, which are used for rapid training to obtain an AI model while improving the generalization of the AI model. The method includes: obtaining an initial artificial intelligence (AI) model and a first numerical interval, the first numerical interval being a numerical value range of a plurality of pieces of attribute data corresponding to an opponent character of the initial AI model; invoking the initial AI model to determine a second numerical interval from the first numerical interval; performing random sampling on the plurality of pieces of attribute data within the second numerical interval to generate a training character set; and performing reinforcement learning training on the initial AI model by using the training character set, to obtain a target AI model.

### CROSS-REFERENCE TO RELATED APPLICATIONS

This application is a Continuation of PCT Application PCT/CN2024/098019, filed Jun. 7, 2024, which claims priority to Chinese Patent Application No. 2023109238917, filed Jul. 25, 2023, each entitled “Artificial Intelligence Model Training Method and Apparatus, Device, Medium, and Program Product” each of which is incorporated by reference in its entirety.

### FIELD

Aspects described herein relate to artificial intelligence, and in particular, to AI model training.

### BACKGROUND

Artificial intelligence (AI) is a new technical science that studies and develops theories, methods, technologies, and application systems for simulating, extending, and expanding human intelligence. Since the birth of artificial intelligence, the theory and technology have become increasingly mature, and the field of application has continued to expand. It is conceivable that the technological products brought by artificial intelligence in the future will be the “containers” of human wisdom. Artificial intelligence can simulate the information process of human consciousness and thinking. Although artificial intelligence is not human intelligence, it can think like humans and may exceed human intelligence.

Artificial intelligence can further be applied to the field of gaming. For example, in open world games, players can freely explore the virtual world and can freely choose when and how to complete game tasks. Therefore, a vast number of items, characters, and the like need to be designed to fill the game world. In other words, game AI models of non-player characters (NPCs) in open world games are particularly important. Specifically, non-player characters (NPCs) in open world games require characteristics such as a vast decision-making space and rich strategic variations. During game interactions, NPCs need to avoid risks through appropriate movement and inflict maximum damage on opposing characters through appropriate attack manners. Due to the rich and varied behavioral strategies of opponents, formulating, selecting, and executing strategies are crucial components for game intelligence systems when confronting such a vast decision-making space and real-time decision-making requirements.

Therefore, there are higher requirements on the training of game AI models of NPCs in games.

### SUMMARY

Aspects described herein provide an artificial intelligence model training method and apparatus, a device, a storage medium, and a program product, which are used for performing rapid training to obtain an AI model while improving the generalization of the AI model.

In view of this, an aspect described herein provides an artificial intelligence model training method, including: obtaining an initial artificial intelligence AI model and a first numerical interval, the first numerical interval being a numerical value range of a plurality of pieces of attribute data corresponding to an opponent character of the initial AI model; invoking the initial AI model to determine a second numerical interval from the first numerical interval; performing random sampling on the plurality of pieces of attribute data within the second numerical interval to generate a training character set; and performing reinforcement learning training on the initial AI model by using the training character set, to obtain a target AI model.

Another aspect described herein provides a model training apparatus, including: an obtaining module, configured to obtain an initial artificial intelligence (AI) model and a first numerical interval, the first numerical interval being a numerical value range of a plurality of pieces of attribute data corresponding to an opponent character of the initial AI model;
a processing module, configured to invoke the initial AI model to determine a second numerical interval from the first numerical interval; and perform random sampling on the plurality of pieces of attribute data within the second numerical interval to generate a training character set; and
a training module, configured to perform reinforcement learning training on the initial AI model by using the training character set, to obtain a target AI model.

Another aspect described herein provides a computer device, including a memory, a processor, and a bus system,
the memory being configured to store a computer program;
the processor being configured to execute the computer program in the memory and perform the method according to the foregoing aspects based on the computer program; and
the bus system being configured to connect the memory and the processor, to cause the memory and the processor to perform communication.

Another aspect described herein provides a computer-readable storage medium having a computer program stored therein, the computer program, when run on a computer, causing the computer to perform the method according to the foregoing aspects.

Another aspect described herein provides a computer program product including a computer program, the computer program, when run on a computer, causing the computer to perform the method according to the foregoing aspects.

It can be seen from the above technical solutions that the aspects described herein have the following advantages: using reinforcement learning to train the AI model can reduce manual model maintenance operations, and achieve rapid model training. In addition, during the training, numerical limitation is performed on attribute data of a battle character to ensure the validity of sample data during the training of the AI model. In addition, random sampling is performed on a selected numerical interval to generate the battle character, enabling the sample data to be more extensive, thereby improving the generalization of the AI model.

### BRIEF DESCRIPTION OF THE DRAWINGS

FIG. 1 is a schematic architectural diagram of a training system according to one or more illustrative aspects described herein.

FIG. 2 is a schematic diagram of an aspect of an artificial intelligence model training method according to one or more illustrative aspects described herein.

FIG. 2a is a schematic flowchart of iterative filtering of a numerical interval according to one or more illustrative aspects described herein.

FIG. 2b is a schematic diagram of an aspect of an NPC control method according to one or more illustrative aspects described herein.

FIG. 2c is a schematic architectural diagram of an NPC control system according to one or more illustrative aspects described herein.

FIG. 3 is a schematic diagram of an aspect of an artificial intelligence model training apparatus according to one or more illustrative aspects described herein.

FIG. 4 is a schematic diagram of another aspect of an artificial intelligence model training apparatus according to one or more illustrative aspects described herein.

FIG. 5 is a schematic diagram of another aspect of an artificial intelligence model training apparatus according to one or more illustrative aspects described herein.

### DETAILED DESCRIPTION

Aspects described herein provide an artificial intelligence model training method and apparatus, a device, and a storage medium, which are used for performing rapid training to obtain an AI model while improving the generalization of the AI model.

In the specification, claims, and the foregoing accompanying drawings described herein, the terms “first”, “second”, “third”, “fourth”, and the like (if any) are configured for distinguishing between similar objects and are not necessarily configured for describing a particular order or sequence. Data used in this way is interchangeable in a suitable case, so that the aspects described herein described herein can, for example, be implemented in an order other than those illustrated or described herein. In addition, the terms “include”, “corresponding to”, and any other variants are intended to cover the non-exclusive inclusion. For example, a process, method, system, product, or device that includes a series of operations or units is not necessarily limited to those expressly listed operations or units, but may include other operations or units not expressly listed or inherent to the process, method, product, or device.

Because the quality of game AI models of NPCs in games directly affects the gaming experience, there are higher requirements on training.

To resolve the foregoing problem, aspects described herein provide an artificial intelligence model training method, enabling sample data to be more extensive, thereby improving the generalization of the AI model.

For ease of understanding, the following describes some terms described herein.

Game artificial intelligence (AI): Game AI refers to the use of artificial intelligence techniques in games to introduce programs or characters that enrich gameplay and enhance player experience.

Reinforcement learning: Reinforcement learning is machine learning in which a system learns from an environment to maximize rewards. In the classification of machine learning, reinforcement learning focuses more on interaction between an agent and the environment. In other words, reinforcement learning is mainly divided into two parts: the agent and the environment. In addition, reinforcement learning includes three elements, namely, a state or an observation, an action, and a reward (which may alternatively be referred to as a reward function). The environment is an external system in which the agent can perceive the system and can take actions based on a perceived state. The agent is a system embedded in the environment, and can change a state of the environment by taking actions. State/Observation: The state is a complete description of the world, containing no hidden information about the world. The observation is a partial description of the state, and may miss some information. Action: Different environments allow different types of actions. In a given environment, a set of valid actions is often referred to as an action space, which includes a discrete action space and a continuous action space. For example, if a maze-solving robot can only move in four directions: east, south, west, and north, the action space is a discrete action space; and if the robot can move in any angle within 360 degrees, the action space is a continuous action space. Reward: It is a scalar feedback signal provided by the environment, and the signal indicates how well a policy of the agent performs at a specific operation. Therefore, based on the foregoing architecture, reinforcement learning mainly has the following several characteristics: trial-and-error learning, meaning that reinforcement learning generally lacks direct guidance information, and the agent needs to interact continuously with the environment to obtain the optimal policy through trial and error; and delayed reward, meaning that reinforcement learning provides little guidance information, and the feedback is often given only after the fact (the last state). In other words, an initial reinforcement learning model learns through continuous trial and error with feedback, and is commonly used for making sequential decisions or control problems, such as game AI or unmanned aerial vehicles.

Open world games: They are a type of video game design that allows players to freely explore the virtual world and can freely choose when and how to complete game tasks. Due to the high degree of freedom in games, it is often necessary to design a vast number of items, characters, and the like to fill the game world.

Non-person characters in games: They are non-human player characters in games and constitute an important part of many games.

Deep learning: It is a neural network algorithm that uses a plurality of complex structures or nonlinear transformation processing layers, providing a better high-level abstraction capability than a shallow neural network.

Machine learning (ML) is a multi-field interdiscipline, and relates to a plurality of disciplines such as the probability theory, statistics, the approximation theory, convex analysis, and the algorithm complexity theory. The machine learning specializes in studying how a computer simulates or implements a human learning behavior to acquire new knowledge or skills, and reorganize an existing knowledge structure, to keep improving performance of the computer. The machine learning is the core of artificial intelligence, is a basic way to make the computer intelligent, and is applied to various fields of the artificial intelligence. The machine learning and the deep learning generally include technologies such as an artificial neural network, a belief network, reinforcement learning, transfer learning, inductive learning, and learning from demonstrations. With a research and progress of an artificial intelligence technology, the artificial intelligence technology is studied and applied to a plurality of fields such as a common smart home, a smart wearable device, a virtual assistant, a smart speaker, smart marketing, unmanned driving, automatic driving, an unmanned aerial vehicle, a robot, smart medical care, and a smart customer service. It is believed that with the development of technologies, the artificial intelligence technology will be applied to more fields, and play an increasingly important role.

The aspects described herein provide an artificial intelligence model training method and apparatus, a device, and a storage medium, which are used for performing rapid training to obtain an AI model, while improving the generalization of the AI model. The following describes an illustrative application of an electronic device provided in the aspects described herein. The electronic device provided in the aspects described herein may be implemented as various types of user terminals, or may be implemented as a server.

By executing the solution of the artificial intelligence model training method provided in the aspects described herein, the electronic device can perform rapid training to obtain an AI model while improving the generalization of the AI model. In other words, it enables the electronic device to rapidly and efficiently update the AI model, making it suitable for a plurality of application scenarios in game scenarios and AI intelligent customer service, for example, a fighting game, a multiplayer online battle arena (MOBA) game, or a shooting-type game in game scenarios.

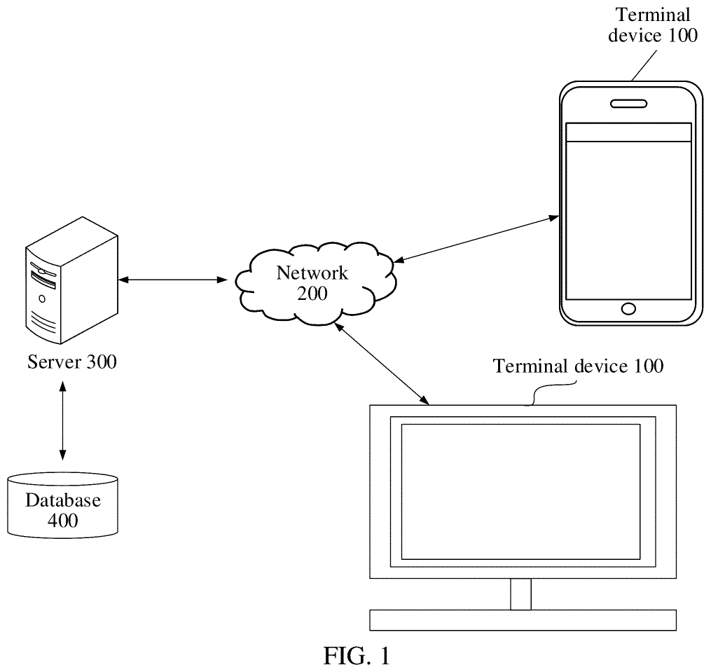

FIG. 1 is an illustrative schematic architectural diagram of an application scenario of an artificial intelligence model training method according to an aspect described herein. To support the artificial intelligence model training method, a terminal device 100 is connected to a server 300 through a network 200, and the server 300 is connected to a database 400. The network 200 may be a wide area network, a local area network, or a combination thereof. A game client is deployed on the terminal device 100. The client may run on the terminal device 100 in the form of a browser or a standalone application (APP). A specific representation form of the client is not limited herein. The server 300 involved described herein may be an independent physical server, or may be a server cluster including a plurality of physical servers or a distributed system, or may be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The terminal device 100 may be a smartphone, a tablet computer, a notebook computer, a palmtop computer, a personal computer, a smart television, a smartwatch, an in-vehicle device, a wearable device, or the like, but is not limited thereto. The terminal device 100 and the server 300 may be directly or indirectly connected through the network 200 in a wired or wireless communication manner. This is not limited described herein. A quantity of servers 300 and a quantity of terminal devices 100 are also not limited. The solution provided described herein may be implemented independently by the terminal device 100, or may be implemented independently by the server 300, or may be implemented collaboratively by the terminal device 100 and the server 300. This is not specifically limited described herein. The database 400 may be simply regarded as an electronic filing cabinet, namely, a place for storing electronic files. Users may perform operations such as adding, querying, updating, and deleting data in the file. The so-called “database” is a set of data stored together in a specific manner, sharable among a plurality of users, with minimal redundancy, and independent of application programs. A database management system (DBMS) is a computer software system designed for managing the database, and generally has basic functions such as storage, retrieval, security, and backup. Database management systems may be classified based on database models they support, for example, relational or extensible markup language (XML) databases; or classified based on computer types they support, for example, server clusters or mobile phones; or classified based on query languages they use, for example, structured query language (SQL) or XQuery; or classified based on performance metric priorities, for example, maximum scale or highest operating speed; or classified in other classification manners. Regardless of the classification manner used, some DBMSs can span categories, for example, can support a plurality of query languages simultaneously. Described herein, the database 400 may be configured to store interaction data between two characters in a current interaction situation. Certainly, a storage location of the interaction data between the two interaction characters in the current interaction situation is not limited to the database, and may also be stored in, for example, the terminal device 100, a blockchain, or a distributed file system of the server 300.

In some aspects, the server 300 may cooperate with the terminal device 100 to perform the artificial intelligence model training method provided in the aspects described herein. In the aspects, a specific procedure may be as follows. The terminal device 100 obtains an initial artificial intelligence (AI) model and a first numerical interval, the first numerical interval being a numerical value range of a plurality of pieces of attribute data corresponding to an opponent character of the initial AI model; invokes the initial AI model to determine a second numerical interval from the first numerical interval; and performs random sampling on the plurality of pieces of attribute data within the second numerical interval to generate a training character set. Then the terminal device 100 invokes the initial AI model to control a non-player character to interact with a character in the training character set to obtain sample data, and then the sample data may be stored in the database 400 or a memory of the terminal device 100. The server 300 trains the initial AI model based on the sample data stored in the database 400 or the terminal 100, to obtain a target AI model. Finally, the server 300 may deploy the target AI model to the terminal device 100, enabling the terminal device 100 to invoke the target AI model to control the non-player character for battles or other operations in an interaction scenario. Alternatively, the server 300 deploys the target AI model to a server corresponding to the client, enabling the terminal device 100 to invoke the target AI model from the server of the client to control the non-player character for battles or other operations in an interaction scenario.

In another aspect, the terminal device 100 independently performs the artificial intelligence model training method provided in the aspects described herein. In this aspect, a specific procedure may be as follows. The terminal device 100 obtains an initial artificial intelligence (AI) model and a first numerical interval, the first numerical interval being a numerical value range of a plurality of pieces of attribute data corresponding to an opponent character of the initial AI model; invokes the initial AI model to determine a second numerical interval from the first numerical interval; and performs random sampling on the plurality of pieces of attribute data within the second numerical interval to generate a training character set. Then the terminal device 100 invokes the initial AI model to control a non-player character to interact with a character in the training character set to obtain sample data, and then the sample data may be stored in the database 400 or a memory of the terminal device 100. The terminal device 100 trains the initial AI model based on the sample data stored in the database 400 or the terminal 100 again, to obtain a target AI model. Finally, the terminal device 100 may deploy the target AI model to the terminal device 100, enabling the terminal device 100 to invoke the target AI model to control the non-player character for battles or other operations. Alternatively, the terminal device 100 deploys the target AI model to a server corresponding to the client, enabling the terminal device 100 to invoke the target AI model from the server of the client to control the non-player character for battles or other operations.

In a specific implementation described herein, related data such as attribute data and interaction data is involved. When the foregoing aspects described herein are applied to a specific product or technology, separate user permission or consent is required for any item, and relevant collection, use, and processing of data are required to comply with relevant laws, regulations, and standards of relevant countries and regions.

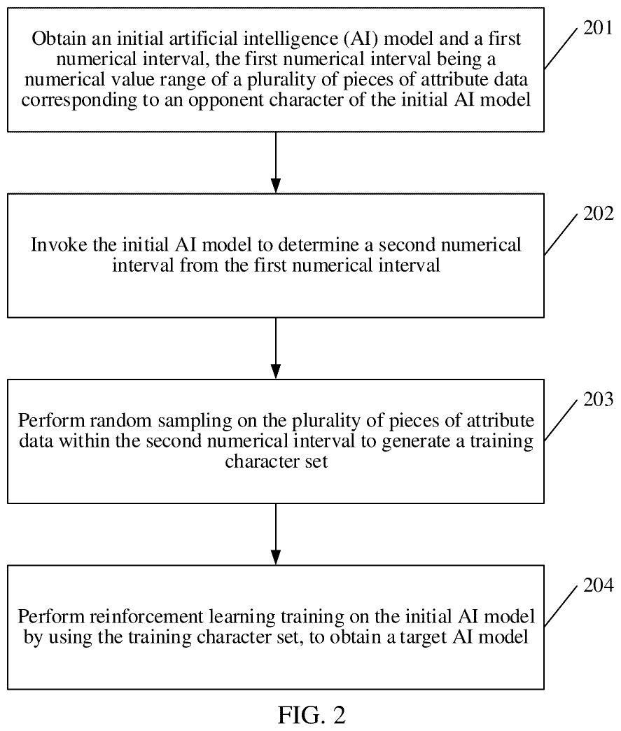

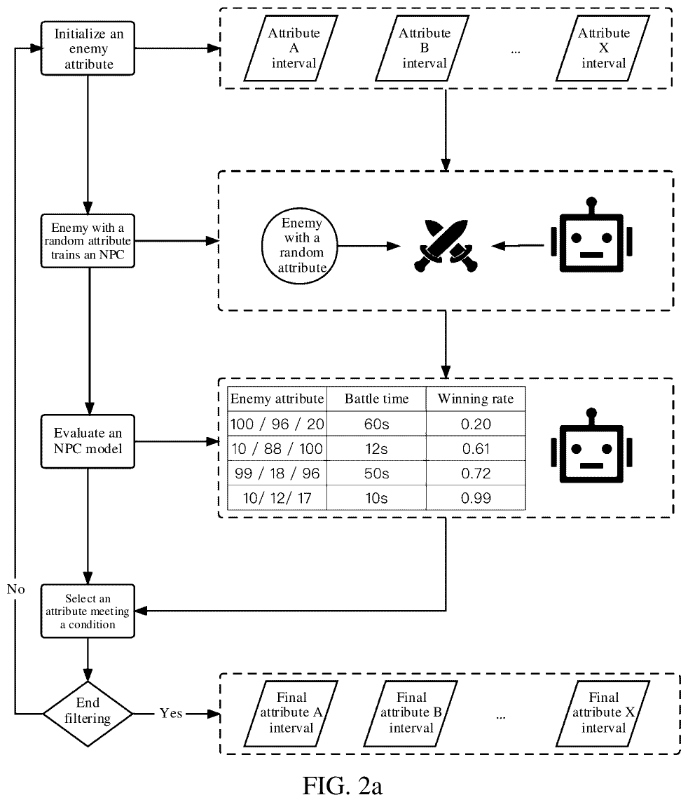

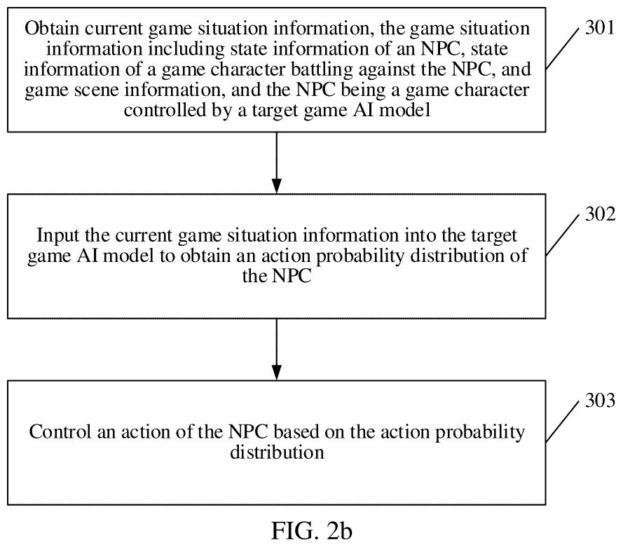

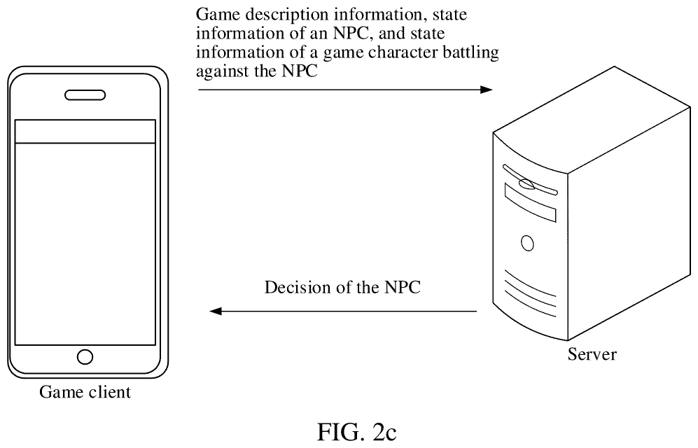

Based on the above description, the following describes the artificial intelligence model training method according to aspects described herein with a terminal device as an execution subject. Referring to FIG. 2, an aspect of the artificial intelligence model training method according to the aspects described herein includes the following operations.

201: Obtain an initial artificial intelligence (AI) model and a first numerical interval,
the initial AI model being configured to control a target character, the first numerical interval being a numerical value range of a plurality of pieces of attribute data corresponding to an opponent character, and the opponent character being configured to interact with the target character.

The target character and the opponent character are characters in the same virtual scenario in which they may interact with each other. For example, the target character and the opponent character may perform question-and-answer interactions in a virtual question-and-answer scenario, or engage in gameplay in a virtual game scenario. This is not limited described herein. An interactive behavior of the target character is controlled by the initial AI model or a subsequent target AI model. The interactive behavior may be passively performed in response to an interactive behavior of the opponent character, or may be actively performed for the opponent character.

For ease of description, in subsequent aspects, an example in which a non-player character is used as the target character is mainly used for description.

In this aspect, before the training begins, the terminal device constructs the initial AI model configured to control the non-player character to perform a corresponding interaction operation, and obtains an initial numerical interval (namely, the first numerical interval) of attribute data of each character in a character set interacting with the non-player character. The attribute data may be understood as a qualitative variable or a quantitative variable of the non-player character in a plurality of dimensions. For example, a game scenario is used as an example for description. Before the training begins, the terminal device constructs an initial game AI model configured to control a non-player game character to perform a corresponding game operation, and obtains an initial numerical interval of attribute data of each game character in a game character set interacting with the non-player game character. Described herein scenario, the attribute data may be information such as attack power, defense power, and health points of the game character. For example, it is set that a numerical interval of the attack power is (0, 100), a numerical interval of the defense power is (0, 100), and a numerical interval of the health points is (0, 100).

In this aspect, the initial AI model may be a deep neural network structure. The deep neural network structure generally includes an input layer, hidden layers, and an output layer. The input layer is the first layer of the deep neural network structure, the output layer is the last layer of the deep neural network structure, and all intermediate layers are used as the hidden layers. The plurality of hidden layers may enhance an expressive capability of the model. In the deep neural network structure, the layers are fully connected, meaning that any neuron in an i^{th} layer is connected to any neuron in an (i+1)^{th} layer. In this aspect, information inputted by the input layer is sample data corresponding to each game character in the game character set, and the hidden layers are configured for performing feature extraction on the sample data and performing feature expression on the sample data. Then, after the sample data passes through the plurality of hidden layers, a predicted action probability distribution corresponding to the sample data is obtained, and a predicted action is obtained based on the predicted action probability distribution.

202: Invoke the initial AI model to determine a second numerical interval from the first numerical interval.

The second numerical interval is adapted to the target character controlled by the initial AI model.

Because it is necessary to generate a training character set based on the second numerical interval subsequently to perform reinforcement learning training on the initial AI model, while the target character might not be adapted to interaction with all characters (within the first numerical interval) in the virtual scenario, or does not have opportunities to interact with characters with a specific numerical value in the virtual scenario, to improve the training quality of the initial AI model, it is necessary to specifically select, for the target character controlled by the initial AI model, the second numerical interval adapted to the target character from the first numerical interval.

In this aspect, the terminal device may invoke the initial AI model to determine the second numerical interval from the first numerical interval through the following specific operations:

performing random sampling on the plurality of pieces of attribute data within the first numerical interval to generate a first character set; performing reinforcement learning training on the initial AI model by using the first character set, to obtain a first AI model; performing random sampling on the plurality of pieces of attribute data within the first numerical interval to generate a second character set; invoking the first AI model to control the non-player character to interact with the second character set to generate a first evaluation result; calculating a first filtering condition value of the first AI model based on the first evaluation result; determining a third numerical interval of the plurality of pieces of attribute data based on the first filtering condition value and a preset filtering threshold; performing random sampling on the plurality of pieces of attribute data within the third numerical interval to generate a third character set; performing reinforcement learning training on the initial AI model by using the third character set, to obtain a second AI model; performing random sampling on the plurality of pieces of attribute data within the third numerical interval to generate a fourth character set; invoking the second AI model to control the non-player character to interact with the fourth character set to generate a second evaluation result; calculating a second filtering condition value of the second AI model based on the second evaluation result; determining a fourth numerical interval of the plurality of pieces of attribute data based on the second filtering condition value and the preset filtering threshold; and repeating the foregoing operations until the numerical interval of the plurality of pieces of attribute data reaches a convergence condition, and outputting a converged numerical interval as the second numerical interval.

In an illustrative solution, the game scenario is used as an example to describe the foregoing process. As shown in FIG. 2a,
the terminal device first performs random sampling on the plurality of pieces of attribute data within the first numerical interval to generate a first game character set. In this case, game characters in the first game character set are used as a training set for training the initial game AI model. Then, the initial game AI model is invoked to control the NPC to interact with each game character in the first game character set to generate sample data in this training process. Then, the initial game AI model is trained based on the sample data to obtain a first game AI model. In this case, random sampling is performed again on the plurality of pieces of attribute data within the first numerical interval to generate a second game character set. In this case, the second game character set is used as an evaluation test set. Then, the first game AI model is invoked to control the NPC to interact with each game character in the second game character set to generate a first evaluation result. Then, a first filtering condition value of the first game AI model is calculated based on the first evaluation result. Finally, a third numerical interval of the plurality of pieces of attribute data is determined based on the first filtering condition value and the preset filtering threshold. Then, a second round of iteration is performed. In this case, the third numerical interval is used as an initial numerical interval. The foregoing operations are repeated until the numerical interval reaches the convergence condition, and a numerical interval finally outputted is used as the second numerical interval.

In other words, to accurately select the second numerical interval adapted to the target character from the first numerical interval, in this aspect described herein, by generating a character set within a numerical range and having the initial AI model control the target character to actually interact with the character set, a generated evaluation result is used as a basis for filtering the numerical range. After a plurality of rounds of iterations, the numerical range is gradually adjusted to obtain an accurate second numerical range adapted to the target character.

Described herein, the random sampling may be understood as randomly selecting values. For example, it is assumed that the plurality of pieces of attribute data are set to be attack power, defense power, and health points, and the first numerical interval is set as follows: A numerical interval of the attack power is (0, 100), a numerical interval of the defense power is (0,100), and a numerical interval of the health points is (0, 100). Therefore, the random sampling process may be understood as randomly selecting values from the numerical intervals of the foregoing three pieces of attribute data each time, to form the game character. For example, for the first time, a numerical value 80 is selected from the numerical interval of the attack power, a numerical value 85 is selected from the numerical interval of the defense power, and a numerical value 90 is selected from the numerical interval of the health points. In this case, the formed game character is a game character A (attack power: 80, defense power: 85, health points: 90).

In some aspects, when the first AI model is invoked to control the non-player character to interact with the second character set to generate the first evaluation result, the following technical solution may be used: The first AI model is invoked to control the non-player character to interact with N characters in the second character set separately for M times to obtain N battle data sets, each battle data set including M groups of battle data, the battle data including but not limited to a battle result and a battle time, each character in the second character set corresponding to one group of attribute data, and M and N being positive integers; and the N battle data sets are used as the first evaluation result.

In an illustrative solution, the game scenario is used as an example for description. In other words, when the terminal device invokes the first game AI model to control the NPC to interact with the second game character set to generate the first evaluation result, the following technical solution may be used: The first game AI model is invoked to control the non-player game character to interact M times with each of N game characters in the second game character set to obtain N battle data sets, each battle data set including M groups of battle data, the battle data including but not limited to a battle result and a battle time, each game character in the second game character set corresponding to one group of attribute data, and M and N being positive integers; and the N battle data sets are used as the first evaluation result.

For example, when the terminal device performs random sampling on the plurality of pieces of attribute data within the first numerical interval to generate the second game character set, it is assumed that the plurality of pieces of attribute data may be set as follows: attack power, defense power, and health points; and it is assumed that the numerical interval may be set as follows: a first numerical interval corresponding to the attack power is (0, 100), a first numerical interval corresponding to the defense power is (0, 100), and a first numerical interval corresponding to the health points is (0, 100). In this case, the second game character set generated by performing random sampling within the first numerical interval may include: a game character 1 (attack power: 10, defense power: 80, health points: 100), a game character 2 (attack power: 1, defense power: 98, health points: 85), a game character 3 (attack power: 55, defense power: 89, health points: 90), a game character 4 (attack power: 10, defense power: 12, health points: 17), and a game character 5 (attack power: 99, defense power: 18, health points: 90). Then, the first game AI model is invoked to control the NPC to interact 10 times with each of the game character 1 to the game character 5 to generate five battle data sets. For example, the battle data set generated by the first game AI model controlling the NPC to interact 10 times with the game character 1 may be as follows: (battle result: NPC wins, battle time: 20 seconds), (battle result: NPC wins, battle time: 20 seconds), (battle result: NPC wins, battle time: 30 seconds), (battle result: NPC wins, battle time: 15 seconds), (battle result: NPC wins, battle time: 10 seconds), (battle result: NPC wins, battle time: 25 seconds), (battle result: NPC loses, battle time: 35 seconds), (battle result: NPC loses, battle time: 40 seconds), (battle result: NPC wins, battle time: 35 seconds), and (battle result: NPC loses, battle time: 20 seconds). Similarly, forms of the battle data sets generated by the first game AI model controlling the NPC to interact 10 times with each of the game character 2 to the game character 5 may be as above, and details are not described herein again.

Due to the high randomness in the interaction results of individual cases, during each round of iteration, by increasing a quantity of opponent characters configured for training the initial AI model and a quantity of interaction rounds to minimize the impact of the individual cases, the obtained evaluation results more closely reflect actual interactions in most cases, thereby improving the accuracy of determining the adaptability to the target character.

In some aspects, after obtaining the first evaluation result, the terminal device may calculate the first filtering condition value of the first AI model based on the first evaluation result in the following method: sequentially performing statistical processing on each of the N battle data sets, to obtain N groups of battle result parameters of the first AI model for the second character set, the N groups of battle result parameters being used as the first filtering condition value. The battle result parameter may include various information describing the battle result, such as the battle result (win, loss, or draw), the battle duration, a skill casting count during the battle, and damage points. This is not limited described herein.

In an illustrative solution, the game scenario is used as an example for description. After obtaining the first evaluation result, the terminal device may calculate the first filtering condition value of the first game AI model based on the first evaluation result in the following method: sequentially performing statistical processing on each of the N battle data sets, to obtain N groups of battle winning rates and battle durations of the first game AI model for the second character set, the N groups of battle winning rates and battle durations being used as the first filtering condition value. Described herein scenario, it is assumed that the battle data set generated by the first game AI model controlling the NPC to interact 10 times with the game character 1 may be as follows: (battle result: NPC wins, battle time: 20 seconds), (battle result: NPC wins, battle time: 20 seconds), (battle result: NPC wins, battle time: 30 seconds), (battle result: NPC wins, battle time: 15 seconds), (battle result: NPC wins, battle time: 10 seconds), (battle result: NPC wins, battle time: 25 seconds), (battle result: NPC loses, battle time: 35 seconds), (battle result: NPC loses, battle time: 40 seconds), (battle result: NPC wins, battle time: 35 seconds), and (battle result: NPC loses, battle time: 20 seconds). In this case, a filtering condition value of the game character 1 may be as follows: The battle winning rate is 7/10=0.7, and the battle duration is (20+20+30+15+10+25+35+40+35+20)/10=25 seconds. Similarly, a filtering condition value of another game character may be obtained by using the same algorithm, and details are not described again herein. All filtering condition values of the game character 1 to the game character 5 are used as the first filtering condition value.

The battle result parameters can intuitively reflect interactions between the target character and the opponent character during the battle. Based on the first evaluation result represented by the battle result parameters, statistical processing can overall demonstrate the adaptability between each battle data set and the target character, thereby improving the accuracy and intuitiveness of the first filtering condition value.

In a possible implementation, the battle result parameter includes a battle winning rate and a battle duration, and the foregoing sequentially perform statistical processing on each of the N battle data sets, to obtain N groups of battle result parameters of the first AI model for the second character set includes the following operations:
performing probabilistic statistics on battle results in a first battle data set, to obtain the battle winning rate, the first battle data set being included in the N battle data sets;
averaging battle times in the first battle data set, to obtain the battle duration; and
sequentially traversing the N battle data sets, to obtain N groups of battle winning rates and battle durations of the first AI model for the second character set.

In this aspect, the battle result parameter is mainly represented by the battle winning rate and the battle duration. The battle winning rate may intuitively reflect the final result of the battle, and the battle duration may intuitively reflect the intensity of the battle. For example, a short battle duration may indicate a one-sided battle with a large power gap, while a long battle duration may indicate a closely contested battle with a small power gap.

By performing probabilistic statistics on the battle results to obtain the winning rate, and averaging the battle times of the determined battle data set, where the battle winning rate and the averaged battle duration are important expression elements in the battle result parameters, and are clearly quantified, a small amount of data information can be used to represent the first battle data set in a simplified and comprehensive manner, thereby improving the expression quality and accuracy of the first filtering condition value.

In some aspects, after obtaining the filtering condition value, the terminal device may determine the third numerical interval from the first numerical interval based on the filtering condition value and the preset filtering threshold through the following specific operations: traversing the N groups of battle result parameters, and determining X groups of battle result parameters from the N groups of battle result parameters based on the preset filtering threshold, X being a positive integer; determining a fifth character set corresponding to the X groups of battle result parameters, the fifth character set being included in the second character set; and determining the third numerical interval based on a plurality of pieces of attribute data corresponding to each character in the fifth character set.

The preset filtering threshold is related to a data dimension involved in the first filtering condition value, that is, related to a data dimension involved in the battle result parameter. For example, when the first filtering condition value includes the battle winning rate and the battle duration, the preset filtering threshold includes at least one of a specified battle winning rate or a specified battle duration.

The preset filtering threshold is configured for selecting, based on a filtering requirement, X characters that are more suitable for the target character from N characters. A specific threshold may be related to the filtering requirement or filtering accuracy.

Based on the preset filtering threshold, the opponent character adapted to the target character on the battle can be intuitively and rapidly selected during each round of iteration, thereby improving the filtering accuracy.

In a possible implementation, the third numerical interval may be determined in the following manner:
determining a maximum value and a minimum value of each piece of attribute data corresponding to each character in the fifth character set; and determining the third numerical interval based on the maximum value and the minimum value. For example, it is assumed that the character is a game character, and a game character 1 (attack power: 10, defense power: 80, health points: 100), a game character 2 (attack power: 1, defense power: 98, health points: 85), a game character 3 (attack power: 55, defense power: 89, health points: 90), a game character 4 (attack power: 10, defense power: 12, health points: 17), and a game character 5 (attack power: 99, defense power: 18, health points: 90) are set. Calculated filtering condition values of the game character 1 to the game character 5 are as follows: The game character 1: a battle winning rate is 0.7, and a battle duration is 25 seconds; the game character 2: a battle winning rate is 0.20, and a battle duration is 60 seconds; the game character 3: a battle winning rate is 0.6, and a battle duration is 12 seconds; the game character 4: a battle winning rate is 0.9, and a battle duration is 10 seconds; and the game character 5: a battle winning rate is 0.7, and a battle duration is 45 seconds. In addition, the preset filtering threshold is set as follows: the winning rate ranges from 0.4 to 0.8, and the battle duration ranges from 25 to 45. In this case, game characters selected based on the foregoing filtering condition value and the preset filtering threshold are: the game character 1 and the game character 5. In this case, the third numerical interval determined based on attribute data corresponding to the game character 1 and the game character 5 may be as follows: attack power (10, 99); defense power (18, 80); and health points (90, 100).

Because the characters in the fifth character set are all opponent characters adapted to the target character in battle during this round of iteration, the numerical range (maximum value, minimum value) of all attribute data of the characters in the fifth character set can effectively identify an adapted numerical range of the target character determined by battle results in this round, thereby accelerating the determining of the third numerical interval.

A specific process of reinforcement learning may be as follows:

The terminal device invokes the initial AI model to control the non-player character to interact with each character in the first character set to obtain the sample data, and then performs reinforcement learning on the initial AI model based on the sample data. In an illustrative solution, when the game scenario is used as an example, the sample data may further include a game scene in a current battle situation and state information of game characters on both sides of the battle. In an illustrative solution, the server invokes the initial game AI model to control an NPC1 to battle against a game character A currently in a game scene A. The NPC1 may use a skill set A, the game character A may use a skill set B, the NPC1 has 80% of health points, the game character A has 50% of health points, and the like.

The sample data includes current game situation information and a label corresponding to the sample data. The game situation information may be game situation information accessible to any NPC, and may include, but is not limited to, at least one of the following: location information of the NPC, health point information, skill information, information about a distance between the NPC and another game character, obstacle information, time information, and score information of the NPC. In some aspects, the time information may be a battle duration or the like. This is not limited described herein. In some aspects, the game situation information further includes, but is not limited to, at least one of the following: location information, health point information, score information, skill information, and the like of an opponent side that are accessible to the NPC. In a battle fighting scenario between the NPC and a player game character or another NPC, the NPC involved in the game situation information refers to a game character on a machine side. Another game character involved in the game situation information may be a game character on a player side or may be another NPC. The label corresponding to the sample data may be action information outputted by the game AI model. An action related to the NPC or an action related to any battle fighting game AI model involved described herein includes, but is not limited to: moving left, moving right, moving up, attacking, jumping, blocking, and the like.

In an illustrative solution, for each match process between two game characters, a process of the server obtaining the sample data may be as follows: In an initial game situation, it is assumed that the game situation information obtained by the NPC1 is S1, and game situation information obtained by the game character A is s1. S1 is inputted into the initial game AI model to obtain an action probability distribution of the NPC1, and then based on the action probability distribution, the game character A performs an action a1. Similarly, s1 is inputted into the initial game AI model to obtain an action probability distribution of the game character A, and then based on the action probability distribution, the game character A performs an action b1. Then, the game enters a next game situation in which the NPC1 performs an action a2, and the game character A performs an action b2, and so on, until a winner is determined between the two game characters. Assuming that the NPC1 finally wins after n battles, samples corresponding to the NPC1 are (S1, a1, 1), (S2, a2, 1), . . . , and (Sn, an, 1), and samples corresponding to the game character A are (s1, b1, 0), (s2, b2, 0), . . . , and (sn, bn, 0). Finally, the samples may form a plurality of pieces of sample data of the initial game AI model. 1 is configured for indicating that the NPC1 wins the battle, and 0is configured for indicating that the NPC1 loses the battle.

Because sample data of a losing side may include many information that clearly helps to avoid losing, the terminal device may select at least one sample from the sample data corresponding to the game character A for mutation. The terminal device may randomly select at least one sample corresponding to the game character A, or may select at least one sample corresponding to the game character A according to a specific rule. In summary, the manner in which the terminal device selects the at least one sample corresponding to the game character A is not limited described herein. For example, the terminal device may randomly select 50% of the samples corresponding to the game character A for mutation. The terminal device may adjust a second action probability distribution corresponding to the samples corresponding to the game character A based on second game situation information corresponding to the samples corresponding to the game character A, to obtain a third action probability distribution. For example, when the game character A is attacked, the terminal device determines that the game character A may select jumping or blocking. If probabilities of jumping and blocking that are obtained based on an action probability distribution in a current situation are not high, the terminal device may perform mutation adjustment on the probabilities of jumping and blocking, for example, by increasing the probability of jumping or blocking. These mutated samples cannot ensure that the game character A will win, but a result better than losing can be obtained. Therefore, the terminal device may mark a winning rate of the game character A as between winning and losing, recorded as 2. Based on this, the server may use the samples corresponding to the NPC1, the samples corresponding to the game character A, and the mutated samples generated from the samples corresponding to the game character A to form the sample data, to train the initial game AI model.

203: Perform random sampling on the plurality of pieces of attribute data within the second numerical interval to generate a training character set.

The terminal device performs random sampling on the plurality of pieces of attribute data within the second numerical interval to generate a training game character set. For example, it is assumed that the plurality of pieces of attribute data may be set as follows: attack power, defense power, and health points; and it is assumed that the numerical interval may be set as follows: a second numerical interval corresponding to the attack power is (40, 90), a second numerical interval corresponding to the defense power is (45, 98), and a second numerical interval corresponding to the health points is (50, 98). In this case, the training game character set generated by performing random sampling within the second numerical interval may include: a game character 1 (attack power: 50, defense power: 80, health points: 85), a game character 2 (attack power: 45, defense power: 98, health points: 85), a game character 3 (attack power: 55, defense power: 89, health points: 90), a game character 4 (attack power: 52, defense power: 81, health points: 90), and a game character 5 (attack power: 65, defense power: 78, health points: 90).

204: Perform reinforcement learning training on the initial AI model by using the training character set, to obtain a target AI model.

In this aspect, a process of the terminal device performing reinforcement learning training on the initial AI model by using the training character set is the same as in the foregoing operation 202, and details are not described herein again.

In some aspects, to enrich styles of the non-player character, the terminal device may further set different reward functions for different non-player characters during reinforcement learning on the initial AI model, to train AI models with different style labels. The style label is configured for identifying a manner in which the target character performs an interactive behavior during interaction with the opponent character, and the style is configured for enabling the target character to simulate an emotion of a user, thereby enhancing the sense of immersion of the user. The different style labels are configured for indicating different interaction manners to be learned by the initial AI model, and interaction manners guided by different style labels may vary. When the initial AI model controls the target character to perform an interaction consistent with the style label, a high reward is obtained, and the reward is reflected by the reward function.

In an illustrative solution, the terminal device may perform reinforcement learning training on the initial AI model by using the training character set and a first reward function of the initial AI model, to obtain a first target AI model, the first reward function being configured for training a first style label of the first target AI model; and perform reinforcement learning training on the initial AI model by using the training character set and a second reward function of the initial AI model, to obtain a second target AI model, the second reward function being configured for training a second style label of the second target AI model, the first target AI model and the second target AI model being used as the target AI model, and the first target AI model and the second target AI model having different style labels.

For example, the game scenario is used as an example. The first target AI model is a first target game AI model, and the second target AI model is a second target game AI model. In addition, when the first target game AI model is trained, if the highest reward is set for a “dodge” action performed by the NPC under the control of the game AI model, a style label of the trained first target game AI model may be “cautious”. Alternatively, when the second target game AI model is trained, if the highest reward is set for an “attack” action performed by the NPC under the control of the game AI model, a style label of the trained second target game AI model may be “aggressive”.

An AI customer service scenario is used as an example. The first target AI model is a first target customer service AI model, and the second target AI model is a second target customer service AI model. In addition, when the first target customer service AI model is trained, if the highest reward is set for a “polite expression” action performed by the NPC under the control of the customer service AI model, a style label of the trained first target customer service AI model may be “polite”. Alternatively, when the second target customer service AI model is trained, if the highest reward is set for an “educational expression” action performed by the NPC under the control of the customer service AI model, a style label of the trained second target customer service AI model may be “rational”

The first target AI model and the second target AI model trained through different style labels can separately control the target character to interact with the opponent character in different interaction manners, thereby effectively improving the interaction experience.

After the AI models with different style labels are trained, whether the trained target AI model meets a model requirement (the model requirement may be set to a consistent style or the like) may be measured based on style indicators corresponding to the style labels, and a specific operation is as follows.

In an illustrative solution, the first target game AI model and the second target game AI model are used as an example for description. It is set that a style indicator of the first target game AI model is a first style indicator, and a style indicator of the second target game AI model is a second style indicator (described herein, the style indicator may be understood as a quantifiable behavior indicator, for example, it may be set that the style indicator is a number of times the NPC performs the “dodge” action and a number of times the NPC performs the “attack” action, or the like, which is not specifically limited herein). Then, the first target game AI model is invoked to control the NPC to interact with each game character in the training game character set to obtain a first style indicator set (which may also be referred to as a first style indicator distribution), and the first target game AI model is invoked to control the NPC to interact with each game character in a test game character set to obtain a second style indicator set (which may also be referred to as a second style indicator distribution). In addition, the second target game AI model is also invoked to control the NPC to interact with each game character in the training game character set to obtain a third style indicator set (which may also be referred to as a third style indicator distribution), and the second target game AI model is invoked to control the NPC to interact with each game character in the test game character set to obtain a fourth style indicator set (which may also be referred to as a fourth style indicator distribution). Then, if the first target game AI model is measured, measurement is performed based on the first style indicator set and the second style indicator set, to obtain a first measurement value. In addition, measurement is performed based on the first style indicator set and the fourth style indicator set, to obtain a second measurement value. Then, whether the first target game AI model meets the model requirement is determined based on the first measurement value and the second measurement value. Similarly, if the second target game AI model is measured, the foregoing solution may also be used, and details are not limited herein.

In this aspect, the terminal device may calculate a measurement value based on each style indicator in the following manner.

In a possible implementation, to achieve quantitative processing of the style indicator, the terminal device needs to standardize outputted style indicators in the training game character set and the test game character set separately. To be specific, the first style indicator set and the third style indicator set are used as one style indicator distribution, which is then standardized to obtain a standardized training style indicator distribution. In addition, the second style indicator set and the third style indicator set are used as one style indicator distribution, which is then standardized to obtain a standardized test style indicator distribution. Then, the measurement value is calculated based on the standardized training style indicator distribution and the standardized test style indicator distribution.

In this aspect, the standardization manner may be calculating a mean and a variance, and then standardizing the style indicators based on the mean and the variance. Alternatively, deviation-based standardization may be used. In other words, as long as the style indicators can be standardized, a specific manner is not limited herein.

Similarly, the manner for calculating the measurement value based on the standardized training style indicator distribution and the standardized test style indicator distribution may include calculating an inter-class distance by using an average distance method, or calculating a KL divergence, or calculating a total variation distance, or calculating a Wasserstein distance, which is not specifically limited herein, as long as the style indicator can be measured.

In an illustrative solution, a game AI model A and a game AI model B with different style labels are selected. N matches are performed on the training set and the test set separately. It is assumed that a style indicator is α, the style indicator of the game AI model A in an i^{th} match on the training set is marked as

$${a}_{i}^{α} ,$$

and the indicator of the game AI model A in a j^{th} match on the test set is

$${A}_{j}^{α} .$$

It may be obtained that distributions of the style indicator o for the game AI model A and the game AI model B on the training set and the test set are

$$\{ {a}_{1}^{α} , … , {a}_{N}^{α} , {b}_{1}^{α} , … , {b}_{N}^{α} , … \} and \{ {A}_{1}^{α} , … , {A}_{N}^{α} , {B}_{1}^{α} , … , {B}_{N}^{α} , … \} .$$

A mean and a variance of the two distributions are calculated respectively as (μ,σ²) and (μ′,σ′²). The indicator distribution in the training set is standardized through

$${a}_{i}^{α} = ( {a}_{i}^{α} - μ ) / σ ,$$

to obtain the indicator distribution

$$\{ {\overline{a}}_{1}^{α} , … , {\overline{a}}_{N}^{α} , {\overline{b}}_{1}^{α} , … , {\overline{b}}_{N}^{α} , … \}$$

on a standardized training set. Similarly, the indicator distribution

$$\{ {\overline{A}}_{1}^{α} , … , {\overline{A}}_{N}^{α} , {\overline{B}}_{1}^{α} , … , {\overline{B}}_{N}^{α} , … \}$$

on a standardized test set is obtained. For the style indicator α, the inter-class distance obtained through the average distance method is used for quantifying generalization (that is, the inter-class distance is used as the measurement value). An inter-class distance between the game AI model A on the training set and the game AI model A on the test set is:

$${D}_{aA} = \sqrt{{\sum }_{i = 1}^{N} {\sum }_{j = 1}^{N} ( {\overline{a}}_{i}^{a} - {\overline{A}}_{j}^{a} ) / {N}^{2}} .$$

Similarly, it may be obtained that an inter-class distance between the game AI model B on the training set and the game AI model B on the test set is: D_{aB}. In actual application, a smaller inter-class distance indicates that distributions of the two are more similar. For the game AI model A, D_{aA}<D_{aX}, ∀X≠A, it indicates that compared with another game AI model, the style indicator of the game AI model A on the test set is most similar with that on the training set, showing good generalization on the test set. Similarly, the generalization of style indicators of all other game AI models can be analyzed.

The following uses a game scenario as an example to describe the application of the target game AI model in the aspects described herein. As shown in FIG. 2b:

301: Obtain current game situation information, the game situation information including state information of an NPC, state information of a game character battling against the NPC, and game scene information, and the NPC being a game character controlled by the target game AI model.

In this aspect, the game situation information may be game situation information accessible to any NPC, and may include, but is not limited to, at least one of the following: location information of the NPC, health point information, skill information, information about a distance between the NPC and another game character, obstacle information, time information, and score information of the NPC. In some aspects, the time information may be a game duration or the like. This is not limited described herein. In some aspects, the game situation information further includes, but is not limited to, at least one of the following: location information, health point information, score information, skill information, and the like of an opponent side that are accessible to the NPC. In a battle fighting scenario, the NPC involved in the game situation information refers to a game character on a machine side. Another game character involved in the game situation information may be a game character on a player side. The label corresponding to the sample data may be action information outputted by the game AI model. An action related to the NPC or an action related to any battle fighting game AI model involved described herein includes, but is not limited to: moving left, moving right, moving up, attacking, jumping, blocking, and the like.

302: Input the current game situation information into the target game AI model to obtain an action probability distribution of the NPC.

The server inputs the current game situation information into the target game AI model to obtain the action probability distribution of the NPC. In this aspect, the action probability distribution outputted by the target game AI model is a probability distribution of actions of the NPC. For example, the actions corresponding to the NPC include moving left, moving right, moving up, attacking, jumping, and blocking, with corresponding execution probabilities of 0.2, 0.3, 0.6, 0.8, 0.3, and 0.2 respectively. In this case, the action probability distribution is (0.2, 0.3, 0.6, 0.8, 0.3, 0.2).

303: Control an action of the NPC based on the action probability distribution.

In this aspect, the action probability distribution outputted by the target game AI model is configured for a client on which the NPC is located to determine an action to execute in a current game situation. For example, the action with the highest probability is executed based on the action probability distribution.

The following describes the application of the target game AI model by using a specific application architecture. As shown in FIG. 2c, a game client and a server corresponding to a game are included. The target game AI model is deployed in the server. In actual application, the game client obtains game description information, state information of an NPC, and state information of a game character battling against the NPC, and transmits the foregoing information to the server. Then, the server invokes the target game AI model to analyze the foregoing information to obtain a decision of the NPC, and transmits the decision to the game client. Based on the decision, the game client controls the NPC to perform a corresponding operation.

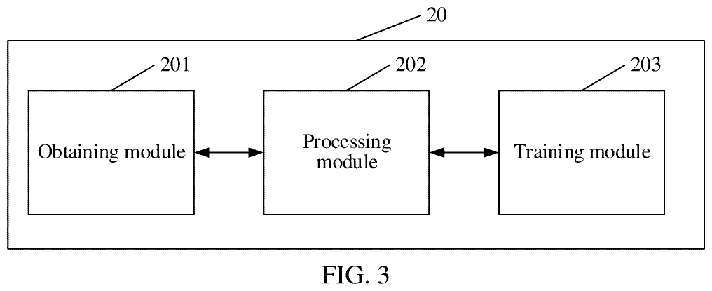

A model training apparatus described herein is described below in detail. FIG. 3 is a schematic diagram of an aspect of a model training apparatus according to an aspect described herein. The model training apparatus 20 includes:
an obtaining module 201, configured to obtain an initial artificial intelligence AI model and a first numerical interval, the initial AI model being configured to control a target character, the first numerical interval being a numerical value range of a plurality of pieces of attribute data corresponding to an opponent character, and the opponent character being configured to interact with the target character;
a processing module 202, configured to invoke the initial AI model to determine a second numerical interval from the first numerical interval, the second numerical interval being adapted to the target character; and perform random sampling on the plurality of pieces of attribute data within the second numerical interval to generate a training character set; and
a training module 203, configured to perform reinforcement learning training on the initial AI model by using the training character set, to obtain a target AI model.

In this aspect described herein, a model training apparatus is provided. By using the foregoing apparatus, using reinforcement learning to train an NPC model in an interaction scenario can reduce manual model maintenance operations, and achieve rapid model training. In addition, during the training, numerical limitation is performed on attribute data of a battle character, to ensure the validity of sample data during the training of the NPC model. In addition, random sampling is performed on a selected numerical interval to generate the battle character, enabling the sample data to be more extensive, thereby improving the generalization of the AI model of the NPC.

In some aspects, based on the aspect corresponding to FIG. 3, in another aspect of the model training apparatus 20 provided in this aspect described herein,
the processing module 202 is configured to perform random sampling on the plurality of pieces of attribute data within the first numerical interval to generate a first character set;
perform reinforcement learning training on the initial AI model by using the first character set, to obtain a first AI model;
perform random sampling on the plurality of pieces of attribute data within the first numerical interval to generate a second character set;
invoke the first AI model to control the non-player character to interact with the second character set to generate a first evaluation result;
calculate a first filtering condition value of the first AI model based on the first evaluation result;
determine a third numerical interval of the plurality of pieces of attribute data based on the first filtering condition value and a preset filtering threshold;
perform random sampling on the plurality of pieces of attribute data within the third numerical interval to generate a third character set;
perform reinforcement learning training on the initial AI model by using the third character set, to obtain a second AI model;
perform random sampling on the plurality of pieces of attribute data within the third numerical interval to generate a fourth character set;
invoke the second AI model to control the non-player character to interact with the fourth character set to generate a second evaluation result;
calculate a second filtering condition value of the second AI model based on the second evaluation result;
determine a fourth numerical interval of the plurality of pieces of attribute data based on the second filtering condition value and the preset filtering threshold; and
repeat the foregoing operations until the numerical interval of the plurality of pieces of attribute data reaches a convergence condition, and outputting a converged numerical interval as the second numerical interval.

In this aspect described herein, a model training apparatus is provided. By using the foregoing apparatus, the numerical interval is limited through the evaluation results of the AI models, which can help exclude extreme sample data, to perform numerical limitation on attribute data of a battle character, thereby ensuring the validity of sample data during training of an NPC model.

In some aspects, based on the aspect corresponding to FIG. 3, in another aspect of the model training apparatus 20 provided in this aspect described herein, the processing module 202 is configured to invoke the first AI model to control the non-player character to interact M times with each of N characters in the second character set to obtain N battle data sets, each battle data set including M groups of battle data, the battle data including but not limited to a battle result and a battle time, each character in the second character set corresponding to one group of attribute data, and M and N being positive integers; and
use the N battle data sets as the first evaluation result.

In this aspect described herein, a model training apparatus is provided. By using the foregoing apparatus, a battle result and a battle time that are obtained through a plurality of interactions with the character are determined as an evaluation result in a filtering process. The evaluation result may be configured for limiting the numerical interval, which can help exclude extreme sample data, to perform numerical limitation on attribute data of a battle character, thereby ensuring the validity of sample data during training of an NPC model.

In some aspects, based on the aspect corresponding to FIG. 3, in another aspect of the model training apparatus 20 provided in this aspect described herein,
the processing module 202 is configured to sequentially perform statistical processing on each of the N battle data sets, to obtain N groups of battle result parameters of the first AI model for the second character set, the N groups of battle result parameters being used as the first filtering condition value.

In this aspect described herein, a model training apparatus is provided. By using the foregoing apparatus, data processing is performed on a plurality of groups of data in an evaluation result, to obtain one group of comparable data, simplifying data filtering and facilitating the use of the evaluation result to limit the numerical interval, which can help exclude extreme sample data, to perform numerical limitation on attribute data of a battle character, thereby ensuring the validity of sample data during training of an NPC model.

In some aspects, based on the aspect corresponding to FIG. 3, the battle result parameter includes a battle winning rate and a battle duration, and in another aspect of the model training apparatus 20 provided in this aspect described herein,
the processing module 202 is configured to perform probabilistic statistics on battle results in a first battle data set, to obtain the battle winning rate, the first battle data set being included in the N battle data sets;
average battle times in the first battle data set, to obtain the battle duration; and
sequentially traverse the N battle data sets, to obtain N groups of battle winning rates and battle durations of the first AI model for the second character set.

In this aspect described herein, a model training apparatus is provided. By using the foregoing apparatus, probabilistic statistics are performed on a plurality of battle results to easily obtain a winning rate of a current AI model battling against a battle object. In addition, battle times are averaged to obtain an averaged battle duration between the current AI model and the battle object, enabling more effective data comparison, thereby facilitating the use of the evaluation result to limit the numerical interval, which can help exclude extreme sample data, to perform numerical limitation on attribute data of a battle character, thereby ensuring the validity of sample data during training of an NPC model.

In some aspects, based on the aspect corresponding to FIG. 3, in another aspect of the model training apparatus 20 provided in this aspect described herein, the processing module 202 is configured to traverse the N groups of battle result parameters, and determine X groups of battle result parameters from the N groups of battle result parameters based on the preset filtering threshold, X being a positive integer;
determine a fifth character set corresponding to the X groups of battle result parameters, the fifth character set being included in the second character set; and
determine the third numerical interval based on a plurality of pieces of attribute data corresponding to each character in the fifth character set.

In this aspect described herein, a model training apparatus is provided. By using the foregoing apparatus, a battle character meeting a requirement is determined through a filtering condition, and different battle characters correspond to different attribute data. Therefore, in a case that a battle character meets the requirement, attribute data corresponding to the battle character also meets the requirement, and then a numerical interval of initial attribute data is narrowed based on the attribute data, which can effectively limit the numerical interval, thereby excluding extreme sample data, and ensuring the validity of sample data during training of an NPC model.

In some aspects, based on the aspect corresponding to FIG. 3, in another aspect of the model training apparatus 20 provided in this aspect described herein, the processing module 202 is configured to determine a maximum value and a minimum value of each piece of attribute data corresponding to each character in the fifth character set; and
determine the third numerical interval based on the maximum value and the minimum value.

In this aspect described herein, a model training apparatus is provided. By using the foregoing apparatus, the numerical interval is determined through a maximum value and a minimum value of attribute data, thereby gradually limiting the numerical interval, which enables effective and accurate limitation on the numerical interval.

In some aspects, based on the aspect corresponding to FIG. 3, in another aspect of the model training apparatus 20 provided in this aspect described herein,
the training module 203 is configured to perform reinforcement learning training on the initial AI model by using the training character set and a first reward function of the initial AI model, to obtain a first target AI model, the first reward function being configured for training a first style label of the first target AI model; and
perform reinforcement learning training on the initial AI model by using the training character set and a second reward function of the initial AI model, to obtain a second target AI model, the second reward function being configured for training a second style label of the second target AI model, the first target AI model and the second target AI model being used as the target AI model, and the first target AI model and the second target AI model having different style labels.

In this aspect described herein, a model training apparatus is provided. By using the foregoing apparatus, for different reinforcement learning solutions, AI models with different styles can be trained by setting different reward functions, thereby enriching behaviors of NPCs and increasing gameplay variety.

In some aspects, based on the aspect corresponding to FIG. 3, in another aspect of the model training apparatus 20 provided in this aspect described herein,
the processing module 202 is configured to invoke the first target AI model to control the non-player character to interact with the training character set to obtain a first style indicator set, and invoke the first target AI model to control the non-player character to interact with the test character set to obtain a second style indicator set, the first style indicator set and the second style indicator set being quantitative indicators corresponding to the first style label;
invoke the second target AI model to control the non-player character to interact with the training character set to obtain a third style indicator set, and invoke the second target AI model to control the non-player character to interact with the test character set to obtain a fourth style indicator set, the third style indicator set and the fourth style indicator set being quantitative indicators corresponding to the second style label;
obtain a first measurement value of the first target AI model on the training character set and the test character set based on the first style indicator set and the second style indicator set;
obtain a second measurement value of the first target AI model on the training character set and a second measurement value of the second target AI model on the test character set based on the first style indicator set and the fourth style indicator set; and
determine, when the first measurement value is less than a first threshold and the first measurement value is less than the second measurement value, that the first target AI model meets a model requirement.

In this aspect described herein, a model training apparatus is provided. By using the foregoing apparatus, style labels are indicated by using style indicators, and distributions of the style indicators on a training set and a test set are obtained. By comparing style indicator distributions of an AI model in two data sets, when the style indicators are similar, it is determined that the AI model meets a training requirement. In addition, the style indicator distributions of AI models in different style labels are also compared. The comparison in two dimensions allows for a more accurate evaluation of the generalization of the AI model.

In some aspects, based on the aspect corresponding to FIG. 3, in another aspect of the model training apparatus 20 provided in this aspect described herein,
the processing module 202 is configured to standardize the first style indicator set and the second style indicator set separately to obtain a first training style indicator set and a first test style indicator set; and
obtain the first measurement value based on the first training style indicator set and the first test style indicator set.

In this aspect described herein, a model training apparatus is provided. By using the foregoing apparatus, the measurement value is calculated after the style indicators are standardized, which can improve the accuracy of the measurement value, thereby enabling better comparison of the style indicators.

In some aspects, based on the aspect corresponding to FIG. 3, in another aspect of the model training apparatus 20 provided in this aspect described herein,
the processing module 202 is configured to measure each style indicator in the first training style indicator set and the first test style indicator set by using an average distance method, to obtain a first inter-class distance, and use the first inter-class distance as the first measurement value.

In this aspect described herein, a model training apparatus is provided. By using the foregoing apparatus, the style indicators in the two data sets are measured by using the inter-class distance, enabling better comparison of the style indicators, thereby determining the generalization of the AI model.

In some aspects, based on the aspect corresponding to FIG. 3, in another aspect of the model training apparatus 20 provided in this aspect described herein,
the processing module 202 is configured to obtain a third measurement value of the second target AI model on the training character set and the test character set based on the third style indicator set and the fourth style indicator set;
obtain, a fourth measurement value of the second target AI model on the training character set and a fourth measurement value of the first target AI model on the test character set based on the third style indicator set and the second style indicator set; and
determine, when the third measurement value is less than the first threshold and the third measurement value is less than the fourth measurement value, that the second target AI model meets the model requirement.

In this aspect described herein, a model training apparatus is provided. By using the foregoing apparatus, style labels are indicated by using style indicators, and distributions of the style indicators on a training set and a test set are obtained. By comparing style indicator distributions of an AI model in two data sets, when the style indicators are similar, it is determined that the AI model meets a training requirement. In addition, the style indicator distributions of AI models in different style labels are also compared. The comparison in two dimensions allows for a more accurate evaluation of the generalization of the AI model.

In some aspects, based on the aspect corresponding to FIG. 3, in another aspect of the model training apparatus 20 provided in this aspect described herein, the target AI model is applied to a game scenario, and the target character is a game character.

In this aspect described herein, a model training apparatus is provided. By using the foregoing apparatus, using reinforcement learning to train an NPC model in a game scenario can reduce manual model maintenance operations, and achieve rapid model training. In addition, during the training, numerical limitation is performed on attribute data of a battle game character, to ensure the validity of sample data during the training of the NPC model. In addition, random sampling is performed on a selected numerical range to generate a battle character, enabling the sample data to be more extensive, thereby improving the generalization of the AI model of the NPC.

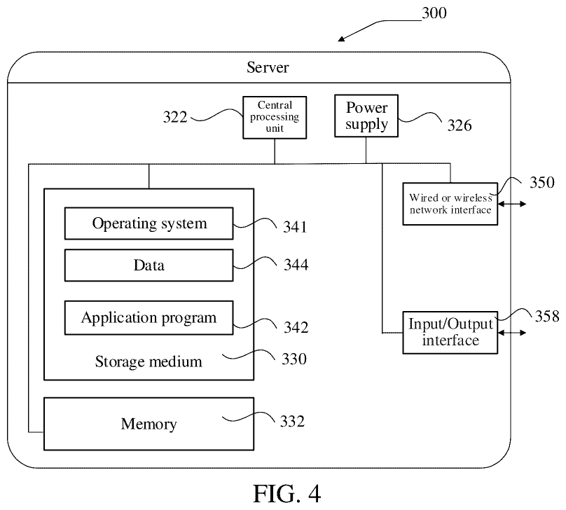

A game model training apparatus provided described herein may be used in a server. FIG. 4 is a schematic structural diagram of a server according to an aspect described herein. The server 300 may vary greatly due to different configurations or performance, and may include one or more central processing units (CPU) 322 (for example, one or more processors) and a memory 332, and one or more storage media 330 (for example, one or more mass storage devices) that store an application program 342 or data 344. The memory 332 and the storage medium 330 may be transient or persistent storages. The program stored in the storage medium 330 may include one or more modules (not marked in the figure), and each module may include a series of instruction operations to the server. Furthermore, the central processing unit 322 may be configured to communicate with the storage medium 330, and perform, on the server 300, the series of instruction operations in the storage medium 330.

The server 300 may further include one or more power supplies 326, one or more wired or wireless network interfaces 350, one or more input/output interfaces 358, and/or one or more operating systems 341, for example, Windows Server™, Mac OS X™, Unix™, Linux™, and FreeBSD™.

The operations performed by the server in the foregoing aspect may be based on the server structure shown in FIG. 4.

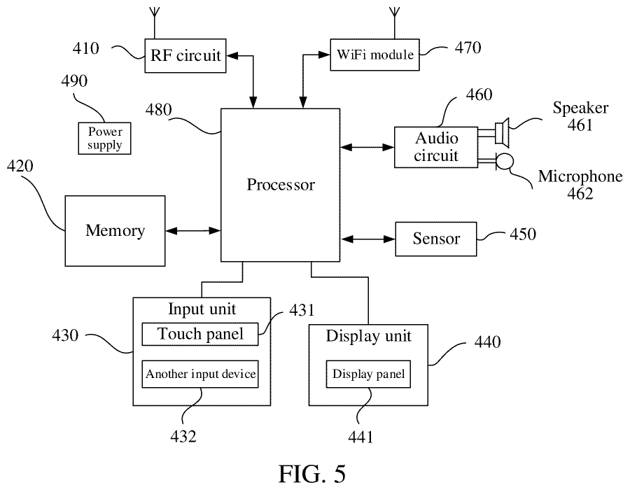

The game model training apparatus provided described herein may be used in a terminal device. Referring to FIG. 5, for ease of description, only a part related to this aspect described herein is shown. For specific technical details not disclosed, refer to the method part in the aspects described herein. In the aspects described herein, description is provided in an example in which the terminal device is a smartphone.

FIG. 5 is a block diagram of a structure of a part of a smartphone related to a terminal device according to an aspect described herein. Referring to FIG. 5, the smartphone includes components such as: a radio frequency (RF) circuit 410, a memory 420, an input unit 430, a display unit 440, a sensor 450, an audio circuit 460, a wireless fidelity (Wi-Fi) module 470, a processor 480, and a power supply 490. A person skilled in the art may understand that the structure of the smartphone shown in FIG. 5 does not constitute a limitation on the smartphone, and the smartphone may include more components or fewer components than those shown in the figure, or some components may be combined, or a different component deployment may be used.

The following makes a detailed description of the components of the smartphone with reference to FIG. 5.

The RF circuit 410 may be configured to receive and transmit signals during information transmission and receiving or a conversation.

The memory 420 may be configured to store a software program and module. The processor 480 runs the software program and module stored in the memory 420, to implement various functional applications and data processing of the smartphone.

The input unit 430 may be configured to receive inputted digit or character information, and generate a keyboard signal input related to the user setting and function control of the smartphone.

The display unit 440 may be configured to display information inputted by the user or information provided for the user, and various menus of the smartphone.

The smartphone may further include at least one sensor 450 such as an optical sensor, a motion sensor, and another sensor.

The audio circuit 460, a speaker 461, and a microphone 462 may provide audio interfaces between the user and the smartphone.

The processor 480 is a control center of the smartphone, and is connected to various parts of the entire smartphone by using various interfaces and lines. By running or executing the software program and/or the module stored in the memory 420, and invoking data stored in the memory 420, the processor executes various functions of the smartphone and processes the data.

The smartphone further includes the power supply 490 (such as a battery) for supplying power to the components.

The operations performed by the terminal device in the foregoing aspects may be based on the structure of the terminal device shown in FIG. 5.

An aspect described herein further provides a computer-readable storage medium, storing a computer program, the computer program, when run on a computer, causing the computer to perform the method described in the foregoing aspects.

An aspect described herein further provides a computer program product including a computer program, the computer program, when run on a computer, causing the computer to perform the method described in the foregoing aspects.

A person skilled in the art may clearly understand that, for the purpose of convenient and brief description, for a detailed working process of the system, apparatus, and unit described above, refer to a corresponding process in the method aspects, and details are not described herein again.

In the several aspects provided described herein, the disclosed system, apparatus, and method may be implemented in other manners. For example, the described apparatus aspects are only illustrative. For example, the division of the units is only a logical function division and may be other divisions during actual implementation. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the apparatus or units may be implemented in electronic, mechanical, or other forms.

The units described as separate parts may or might not be physically separate. Parts displayed as units may or might not be physical units, and may be located in one position, or may be distributed on a plurality of network units. Some or all of the units may be selected according to an actual requirement to achieve the objectives of the solutions in the aspects.

In addition, functional units in the aspects described herein may be integrated into one processing unit, or each of the units may exist alone physically, or two or more units are integrated into one unit. The integrated unit may be implemented in the form of hardware, or may be implemented in the form of a software function unit.

When the integrated unit is implemented in the form of a software functional unit and sold or used as an independent product, the integrated unit may be stored in a computer-readable storage medium. Based on such an understanding, the technical solutions described herein essentially, or the part contributing to the related art, or all or a part of the technical solutions may be implemented in the form of a software product. The computer software product is stored in a storage medium and includes several instructions for instructing a computer device (which may be a personal computer, a server, or a network device) to perform all or some of the operations of the method described in the aspects described herein. The foregoing storage medium includes: any medium that can store program code, such as a USB flash drive, a removable hard disk, a read-only memory (ROM), a random access memory (RAM), a magnetic disk, a compact disc, or the like.

The foregoing aspects are merely intended for describing the technical solutions described herein; not for limiting the protective scope. It is to be understood by a person of ordinary skill in the art that although aspects described herein have been described in detail with reference to the foregoing aspects, modifications can be made to the technical solutions described in the foregoing aspects, or equivalent replacements can be made to some technical features in the technical solutions, as long as such modifications or replacements do not cause the essence of corresponding technical solutions to depart from the spirit and scope of the technical solutions of the aspects described herein.

What is claimed is:

1. A computer-implemented method, comprising:
obtaining an initial artificial intelligence (AI) model and a first numerical interval, the initial AI model being configured to control a target character, the first numerical interval being a numerical value range of a plurality of pieces of attribute data corresponding to an opponent character, and the opponent character being configured to interact with the target character;
invoking the initial AI model to determine a second numerical interval from the first numerical interval, the second numerical interval being adapted to the target character;
performing random sampling on the plurality of pieces of attribute data within the second numerical interval to generate a training character set; and
performing reinforcement learning training on the initial AI model by using the training character set, to obtain a target AI model.

2. The method according to claim 1, wherein the invoking the initial AI model comprises:
performing random sampling on the plurality of pieces of attribute data within the first numerical interval to generate a first character set;
performing reinforcement learning training on the initial AI model by using the first character set, to obtain a first AI model;
performing random sampling on the plurality of pieces of attribute data within the first numerical interval to generate a second character set;
invoking the first AI model to control a non-player character to interact with the second character set to generate a first evaluation result;
calculating a first filtering condition value of the first AI model based on the first evaluation result;
determining a third numerical interval of the plurality of pieces of attribute data based on the first filtering condition value and a preset filtering threshold;
performing random sampling on the plurality of pieces of attribute data within the third numerical interval to generate a third character set;
performing reinforcement learning training on the initial AI model by using the third character set, to obtain a second AI model;
performing random sampling on the plurality of pieces of attribute data within the third numerical interval to generate a fourth character set;
invoking the second AI model to control the non-player character to interact with the fourth character set to generate a second evaluation result;
calculating a second filtering condition value of the second AI model based on the second evaluation result;
determining a fourth numerical interval of the plurality of pieces of attribute data based on the second filtering condition value and the preset filtering threshold; and
repeating the foregoing operations until the numerical interval of the plurality of pieces of attribute data reaches a convergence condition, and outputting a converged numerical interval as the second numerical interval.

3. The method according to claim 2, wherein the invoking the first AI model to control the non-player character to interact with the second character set to generate a first evaluation result comprises:
invoking the first AI model to control the non-player character to interact M times with each of N characters in the second character set to obtain N battle data sets, each battle data set comprising M groups of battle data, the battle data comprising but not limited to a battle result and a battle time, each character in the second character set corresponding to one group of attribute data, and M and N being positive integers; and
using the N battle data sets as the first evaluation result.

4. The method according to claim 3, wherein the calculating a first filtering condition value of the first AI model based on the first evaluation result comprises:
sequentially performing statistical processing on each of the N battle data sets, to obtain N groups of battle result parameters of the first AI model for the second character set, the N groups of battle result parameters being used as the first filtering condition value.

5. The method according to claim 4, wherein the battle result parameter comprises a battle winning rate and a battle duration, and the sequentially performing statistical processing on each of the N battle data sets, to obtain N groups of battle result parameters of the first AI model for the second character set comprises:
performing probabilistic statistics on battle results in a first battle data set, to obtain the battle winning rate, the first battle data set being comprised in the N battle data sets;
averaging battle times in the first battle data set, to obtain the battle duration; and
sequentially traversing the N battle data sets, to obtain N groups of battle winning rates and battle durations of the first AI model for the second character set.

6. The method according to claim 4, wherein the determining the third numerical interval comprises:
traversing the N groups of battle result parameters, and determining X groups of battle result parameters from the N groups of battle result parameters based on the preset filtering threshold, X being a positive integer;
determining a fifth character set corresponding to the X groups of battle result parameters, the fifth character set being comprised in the second character set; and
determining the third numerical interval based on a plurality of pieces of attribute data corresponding to each character in the fifth character set.

7. The method according to claim 6, wherein the determining the third numerical interval based on a plurality of pieces of attribute data corresponding to each character in the fifth character set comprises:
determining a maximum value and a minimum value of each piece of attribute data corresponding to each character in the fifth character set; and
determining the third numerical interval based on the maximum value and the minimum value.

8. The method of claim 1, wherein the performing reinforcement learning training on the initial AI model by using the training character set, to obtain a target AI model comprises:
performing reinforcement learning training on the initial AI model by using the training character set and a first reward function of the initial AI model, to obtain a first target AI model, the first reward function being configured for training a first style label of the first target AI model; and
performing reinforcement learning training on the initial AI model by using the training character set and a second reward function of the initial AI model, to obtain a second target AI model, the second reward function being configured for training a second style label of the second target AI model, the first target AI model and the second target AI model being used as the target AI model, and the first target AI model and the second target AI model having different style labels.

9. The method according to claim 8, further comprising:
invoking the first target AI model to control the non-player character to interact with the training character set to obtain a first style indicator set, and invoking the first target AI model to control the non-player character to interact with a test character set to obtain a second style indicator set, the first style indicator set and the second style indicator set being quantitative indicators corresponding to the first style label, and the test character set being generated by performing random sampling on the plurality of pieces of attribute data within the second numerical interval;
invoking the second target AI model to control the non-player character to interact with the training character set to obtain a third style indicator set, and invoking the second target AI model to control the non-player character to interact with the test character set to obtain a fourth style indicator set, the third style indicator set and the fourth style indicator set being quantitative indicators corresponding to the second style label;
obtaining a first measurement value of the first target AI model on the training character set and the test character set based on the first style indicator set and the second style indicator set;
obtaining a second measurement value of the first target AI model on the training character set and a second measurement value of the second target AI model on the test character set based on the first style indicator set and the fourth style indicator set; and
determining, when the first measurement value is less than a first threshold and the first measurement value is less than the second measurement value, that the first target AI model meets a model requirement.

10. The method according to claim 9, wherein the obtaining a first measurement value of the first target AI model on the training character set and the test character set based on the first style indicator set and the second style indicator set comprises:
standardizing the first style indicator set and the second style indicator set separately to obtain a first training style indicator set and a first test style indicator set; and
obtaining the first measurement value based on the first training style indicator set and the first test style indicator set.

11. The method according to claim 10, wherein the obtaining the first measurement value based on the first training style indicator set and the first test style indicator set comprises:
measuring each style indicator in the first training style indicator set and the first test style indicator set by using an average distance method, to obtain a first inter-class distance, the first inter-class distance being used as the first measurement value.

12. The method of claim 9, further comprising:
obtaining a third measurement value of the second target AI model on the training character set and the test character set based on the third style indicator set and the fourth style indicator set;
obtaining, a fourth measurement value of the second target AI model on the training character set and a fourth measurement value of the first target AI model on the test character set based on the third style indicator set and the second style indicator set; and
determining, when the third measurement value is less than the first threshold and the third measurement value is less than the fourth measurement value, that the second target AI model meets the model requirement.

13. The method of claim 1, wherein the target AI model is applied to a game scenario, and the target character is a game character.

14. One or more non-transitory computer readable media comprising computer readable instructions which, when executed by a processor, configure a data processing system to perform:
obtaining an initial artificial intelligence (AI) model and a first numerical interval, the initial AI model being configured to control a target character, the first numerical interval being a numerical value range of a plurality of pieces of attribute data corresponding to an opponent character, and the opponent character being configured to interact with the target character;
invoking the initial AI model to determine a second numerical interval from the first numerical interval, the second numerical interval being adapted to the target character;
performing random sampling on the plurality of pieces of attribute data within the second numerical interval to generate a training character set; and
performing reinforcement learning training on the initial AI model by using the training character set, to obtain a target AI model.

15. The computer readable media according to claim 14, wherein the invoking the initial AI model comprises:
performing random sampling on the plurality of pieces of attribute data within the first numerical interval to generate a first character set;
performing reinforcement learning training on the initial AI model by using the first character set, to obtain a first AI model;
performing random sampling on the plurality of pieces of attribute data within the first numerical interval to generate a second character set; invoking the first AI model to control a non-player character to interact with the second character set to generate a first evaluation result;
calculating a first filtering condition value of the first AI model based on the first evaluation result;
determining a third numerical interval of the plurality of pieces of attribute data based on the first filtering condition value and a preset filtering threshold;
performing random sampling on the plurality of pieces of attribute data within the third numerical interval to generate a third character set;
performing reinforcement learning training on the initial AI model by using the third character set, to obtain a second AI model;
performing random sampling on the plurality of pieces of attribute data within the third numerical interval to generate a fourth character set;
invoking the second AI model to control the non-player character to interact with the fourth character set to generate a second evaluation result;
calculating a second filtering condition value of the second AI model based on the second evaluation result;
determining a fourth numerical interval of the plurality of pieces of attribute data based on the second filtering condition value and the preset filtering threshold; and
repeating the foregoing operations until the numerical interval of the plurality of pieces of attribute data reaches a convergence condition, and outputting a converged numerical interval as the second numerical interval.

16. The computer readable media according to claim 15, wherein the invoking the first AI model to control the non-player character to interact with the second character set to generate a first evaluation result comprises:
invoking the first AI model to control the non-player character to interact M times with each of N characters in the second character set to obtain N battle data sets, each battle data set comprising M groups of battle data, the battle data comprising but not limited to a battle result and a battle time, each character in the second character set corresponding to one group of attribute data, and M and N being positive integers; and
using the N battle data sets as the first evaluation result.

17. The computer readable media according to claim 16, wherein the calculating a first filtering condition value of the first AI model based on the first evaluation result comprises:
sequentially performing statistical processing on each of the N battle data sets, to obtain N groups of battle result parameters of the first AI model for the second character set, the N groups of battle result parameters being used as the first filtering condition value.

18. The computer readable media according to claim 17, wherein the battle result parameter comprises a battle winning rate and a battle duration, and the sequentially performing statistical processing on each of the N battle data sets, to obtain N groups of battle result parameters of the first AI model for the second character set comprises:
performing probabilistic statistics on battle results in a first battle data set, to obtain the battle winning rate, the first battle data set being comprised in the N battle data sets;
averaging battle times in the first battle data set, to obtain the battle duration; and
sequentially traversing the N battle data sets, to obtain N groups of battle winning rates and battle durations of the first AI model for the second character set.

19. The computer readable media of claim 14, wherein the performing reinforcement learning training on the initial AI model by using the training character set, to obtain a target AI model comprises:
performing reinforcement learning training on the initial AI model by using the training character set and a first reward function of the initial AI model, to obtain a first target AI model, the first reward function being configured for training a first style label of the first target AI model; and
performing reinforcement learning training on the initial AI model by using the training character set and a second reward function of the initial AI model, to obtain a second target AI model, the second reward function being configured for training a second style label of the second target AI model, the first target AI model and the second target AI model being used as the target AI model, and the first target AI model and the second target AI model having different style labels.

20. A system, comprising:
a processor; and
memory storing computer readable instructions which, when executed by the processor, configure the system to perform:
obtaining an initial artificial intelligence (AI) model and a first numerical interval, the initial AI model being configured to control a target character, the first numerical interval being a numerical value range of a plurality of pieces of attribute data corresponding to an opponent character, and the opponent character being configured to interact with the target character;
invoking the initial AI model to determine a second numerical interval from the first numerical interval, the second numerical interval being adapted to the target character;
performing random sampling on the plurality of pieces of attribute data within the second numerical interval to generate a training character set; and
performing reinforcement learning training on the initial AI model by using the training character set, to obtain a target AI model.
